(19) United States
(12) Patent Application Publication
(10) Pub. No.: US 2009/0114204 A1
(43) Pub. Date: May 7, 2009

(54) CUTTING TOOL AND CUTTING DEVICE THAT HAVE DISK-LIKE CUTTING BLADE

(76) Inventor: Kazumasa Ohnishi, Niigata (JP)

Correspondence Address: NIXON PEABODY, LLP, 401 9TH STREET, NW, SUITE 900, WASHINGTON, DC, 20004-2128, US

(21) Appl. No.: 11/915,340

(22) PCT Filed: Dec. 27, 2005
(86) PCT No.: PCT/JP2005/023961

§ 371 Date: Nov. 23, 2007

(30) Foreign Application Priority Data
May 23, 2005 (JP) 2005-178517

(51) Int. Cl. B28D 1/04; B26D 7/08

(52) U.S. Cl. 125/13.03; 125/13.01; 83/956

(57) ABSTRACT

A cutting tool (20) capable of cutting or grooving an article with high accuracy independent of the thickness of a cutting disk blade used has a cutting disk blade (22) having a through-hole (21) at its center, an annular rigid plate (23) coaxially fixed to each face of the cutting blade (22), and an annular ultrasonic oscillator (24) having a smaller outer diameter than the rigid plate (23) which is coaxially fixed to an outer face of each rigid plate (23) or to the cutting blade (22) in contact with an inner circumferential edge of each rigid plate (23).

### FIELD OF THE INVENTION

This invention relates to a cutting tool having a cutting disk blade and a cutting machine which are favorably employable for cutting or grooving an article of rigid and fragile material such as inorganic glass, silicon, or silicon nitride.

### BACKGROUND OF THE INVENTION

A cutting machine equipped with a cutting disk blade as a cutting tool is widely employed for cutting or grooving an article of rigid and fragile material such as inorganic glass, silicon, or silicon nitride. The cutting machine is operated to bring a circumferential edge of the disk blade under rotation into contact with the article to be processed.

In the cutting procedure using the cutting machine for cutting a silicon wafer into a great number of silicon chips, it is required that the production yield (number of the silicon chips obtained by cutting one silicon wafer) is high. For this reason, the cutting machine is equipped with a thin disk blade which can produce a less amount of silicon powder. Moreover, the thin disk blade is effective in grooving the article with a fine pitch.

It is known that accuracy of cutting or grooving an article is enhanced by subjecting a cutting blade of the cutting machine to ultrasonic vibration in the radial direction. This is because the ultrasonic vibration reduces friction between the cutting blade and the article under processing and further reduces deformation of the article which is generally caused by heat produced by the friction.

FIG. 1 illustrates a side section showing a structure of a conventional cutting machine which is given in Japanese Provisional Patent Publication 2004-291636. The cutting machine 10 of FIG. 1 comprises a rotation-driving device 11, a rotating shaft 12 which is rotatably supported by a bearing of the driving device 11, a cutting disk blade 14 arranged around the rotating shaft 12, a pair of annular ultrasonic oscillators 15 each of which is fixed to each face of the blade 14, a rotary transformer 17 attached to the front end of the rotating shaft 12, and an electric power source 18 which is connected to the ultrasonic oscillator 15 via the rotary transformer 17.

The rotary transformer 17 is composed of a power supply unit 17a and a power receiving unit 17b, each of which comprises a coil 16a and a core 16b. The power supply unit 17a of the rotary transformer 17 is fixed to a supporting pole 19 and the power receiving unit 17b is fixed to the front end of the rotating shaft 12. The rotary transformer 17 is used to supply an electric energy to each ultrasonic oscillator 15 (which rotates with the blade 14) from the electric power source 18 in the course of the cutting or grooving procedure.

In the cutting tool attached to the cutting machine 10, a ultrasonic oscillator 15 is directly fixed to the surface of the cutting blade 14. It is described that ultrasonic oscillation generated by the ultrasonic oscillator 15 is efficiently and stably applied to the cutting blade 14 and hence that excellent cutting performance is stably shown.

In the cutting tool shown in FIG. 1, the oscillation generated by the ultrasonic oscillator is efficiently and stably applied to the cutting blade and hence excellent it is able to cut or groove stably an article under processing with high accuracy. Particularly, if the cutting tool utilizes a thin cutting blade, the article can be cut with high accuracy and high productivity or grooved with high accuracy and fine pitch.

However, there are the following problems in the known cutting tool: when the cutting blade is very thin (thickness of 1 mm or less, particularly thickness 100 μm or less ), the cutting blade under application of ultrasonic oscillation is apt to vibrate not only in the radial direction but also in the thickness direction, that is, deflective vibration occurs, since the thin cutting blade is apt to deflect in the thickness direction. If the cutting blade vibrates in the thickness direction in the deflective vibration mode, the article under processing is cut or grooved with an enlarged width as compared with the thickness of the cutting blade. Therefore, the cutting or grooving accuracy decreases, and an amount of powdered material increases. Moreover, wear of the edge of the cutting blade increases.

### SUMMARY OF THE INVENTION

It is an object of the present invention to provide a cutting tool which can cut or groove an article under processing with a high accuracy regardless of thickness of the cutting blade.

It is another object of the invention to provide a cutting tool which is favorably employable for cutting an article with high accuracy and high yield or grooving an article with high accuracy and fine pitch.

There is provided by the invention a cutting tool comprising a cutting disk blade having a through-hole at a center thereof, an annular rigid plate coaxially fixed to each face of the cutting blade, and an annular ultrasonic oscillator having a smaller outer diameter than the rigid plate which is coaxially fixed to an outer face of each rigid plate or to the cutting blade in contact with an inner circumferential edge of each rigid plate.

In the present specification, “cutting tool” includes a tool for partially cutting an article, that is, for grooving an article. The “outer diameter of rigid plate” means an outer diameter of the surface on which the ultrasonic oscillator is placed in the case that the ultrasonic oscillator is placed in contact with the surface of the rigid plate, and means a diameter of a surface having a smaller outer diameter in the case that the ultrasonic oscillator is placed in contact with the inner circumferential edge of the rigid plate. The “outer diameter of ultrasonic oscillator” means an outer diameter of the surface placed in contact with the rigid plate in the case that the ultrasonic oscillator is placed in contact with the surface of the rigid plate, and means an outer diameter of the portion which is in contact with the inner circumferential edge of the rigid plate in the case that the ultrasonic oscillator is placed in contact with the inner circumferential edge of the rigid plate.

Preferred embodiments of the cutting tool according to the invention are described below.

(1) The cutting disk blade has a thickness of 1 mm or less.

(2) Each rigid plate has a thickness of 10% of an outer diameter thereof.

(3) Each rigid plate is covered with resinous material on an area which is outer than the ultrasonic oscillator.

(4) Each rigid plate has an annular thicker area on a periphery thereof which is in contact with an outer circumferential edge of the ultrasonic oscillator.

(5) The cutting disc blade is bound to both rigid plates and both ultrasonic oscillators by means of a binding means provided to a circumferential edge of the through-hole of the cutting disk blade.

There is further provided by the invention a cutting machine comprising a bearing; a rotating shaft having a pair of flanges extended radially which is rotatably supported by the bearing; a cutting tool comprising a cutting disk blade having a through-hole at a center thereof, an annular rigid plate coaxially fixed to each face of the cutting blade, and an annular ultrasonic oscillator having a smaller outer diameter than the rigid plate which is coaxially fixed to an outer face of each rigid plate or to the cutting blade in contact with an inner circumferential edge of each rigid plate, the cutting tool being fixed around the rotating shaft and supported by the pair of flanges on the rigid plate in an area adjacent to an outer circumferential edge thereof; and an electric power source electrically connected to each ultrasonic oscillator.

In the specification, the cutting machine” include a machine for partially cutting an article, that is, for grooving an article.

Preferred embodiments of the cutting machine according to the invention are described below.

(1) The cutting machine further comprises a rotary transformer composed of an electric power supply unit fixed to the bearing and an electric receiving unit fixed to the rotating shaft, the electric power source being connected to each ultrasonic oscillator via the rotary transformer.

(2) The pair of flanges support the cutting tool via resinous material.

There is furthermore provided by the invention oscillation-applying means comprising a pair of annular rigid plates each having a through-hole at a center thereof and an annular ultrasonic oscillator having a smaller outer diameter than the rigid plate which is coaxially fixed to an outer face of each rigid plate or arranged in contact with an inner circumferential edge of each rigid plate.

The cutting blade of the cutting tool according to the invention is advantageous in that even a thin blade is used, the blade hardly vibrates in the thickness direction, because the blade is reinforced by a pair of the rigid plates arranged on both faces of the blade. Therefore, the cutting tool according to the invention can cut or groove an article with high accuracy, regardless of the thickness of the blade. Moreover, if a thin cutting blade is employed in the cutting tool of the invention, an article can be cut with high accuracy and high productivity or grooved with high accuracy and fine pitch.

### BRIEF DESCRIPTION OF THE DRAWING

FIG. 1 is a side section of a cutting machine according to prior art.

FIG. 2 is a front view of a cutting tool according to the invention.

FIG. 3 is a side section sectioned along III-III line shown in FIG. 2.

FIG. 4 is a side section of a cutting machine according to the invention.

FIG. 5 is a side section of another cutting machine according to the invention. Note that the power source is not described.

FIG. 6 is a side section of a further cutting machine according to the invention. Note that the power source is not described.

FIG. 7 is a side section of a still further cutting machine according to the invention. Note that the power source is not described.

FIG. 8 is a side section of a still further cutting machine according to the invention. Note that the power source is not described.

The numerals mean the following: 10: cutting machine, 11: rotation-driving device, 12: rotating shaft, 14: cutting blade, 15: ultrasonic oscillator, 16a: coil, 16b: core, 17: rotary transformer, 17a: electric power supply unit, 17b: electric power-receiving unit, 18: electric power source, 19: supporting pole, 20, 20a, 20b, 20c, 20d: cutting tool, 21: through-hole, 22: cutting blade; 23: rigid plate, 23a: thicker portion, 23b: protrusion, 24: ultrasonic oscillator, 25: insulating layer, 26: resinous material layer, 31, 32: electric wiring, 33: support, 34: bolt, 35: nut, 40: cutting machine, 41: bearing, 42a, 42b: flange, 43: rotating shaft, 43a: groove, 44: electric power source, 45: rotary transformer, 45a: electric power supply unit, 45b: electric power-receiving unit, 46a: stator core, 46b: rotor core, 47a: stator coil, 47b: rotor coil, 50: cutting machine, 51: binding means, 51a: bolt, 51b: nut, 60, 70, 80: cutting machine.

### DETAILED DESCRIPTION OF THE INVENTION

The cutting tool of the invention is described first, referring to the attached drawings.

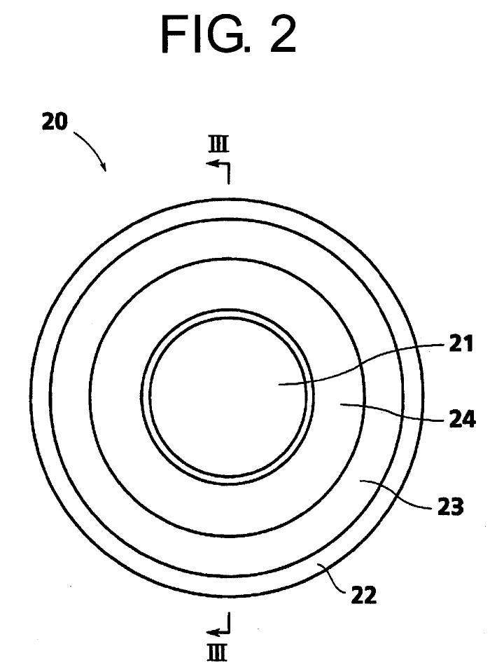

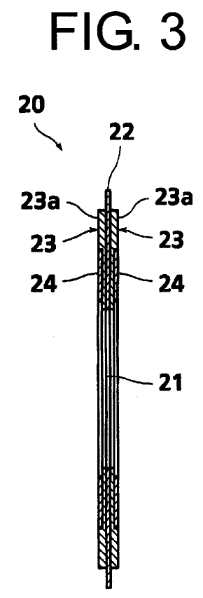

FIG. 2 is a front view illustrating one embodiment of the cutting tool according to the invention. FIG. 3 is a side section of the cutting tool taken along the line III-III shown in FIG. 2.

In FIGS. 2 and 3, the cutting tool 20 is composed of a cutting disk blade 22 having a through-hole 21 at its center, an annular rigid plate 23 coaxially fixed to each face of the cutting blade 22, and an annular ultrasonic oscillator 24 having a smaller outer diameter than the rigid plate 23 which is coaxially fixed to an outer face of each rigid plate 23.

The cutting disk blade 22 can be a known cutting blade such as a circular saw or a cutting disk blade composed of a disk substrate and abrasive grains fixed onto the surfaces of the disk substrate.

The disk substrate for the cutting blade can be made of metallic material such as aluminum, iron, or stainless steel.

The abrasive grains can be diamond grains, alumina grains, silica grains, iron oxide grains, chromium oxide grains, or cubic boron nitride grains. The abrasive grains generally have a mean diameter of 0.1 to 10 μm.

The abrasive grains are fixed to the surfaces of the disk substrate by plating the substrate in a plating bath in which the abrasive grains are suspended. Otherwise, the abrasive grains can be fixed to the surfaces of the disk substrate by the use of binder resin (e.g., phenol-formalin resin).

The rigid plate 23 can be made of metallic material such as aluminum alloy or titanium, or ceramic material such as alumina. The rigid plate 23 can be fixed to the surface of the cutting blade 22 using an adhesive.

The adhesive can be an adhesive of hot melt type comprising a thermoplastic resin and a water-soluble wax. If such adhesive is used, the rigid plate 23 equipped with the ultrasonic oscillator 24 (i.e., ultrasonic oscillation-applying means) can be easily detached from the cutting blade 22 by placing the cutting tool 20 is immersed in a warm water and dissolving the cured adhesive therein. Therefore, if the cutting edge of the cutting blade wears away as a result of its use, the ultrasonic oscillation-applying means can be detached from the cutting blade, and then can be attached to a new cutting blade. This means that an expensive ultrasonic oscillator can be reused without disposal.

The ultrasonic oscillator 24 is, for example, a piezoelectric oscillator comprising an annular piezoelectric element and electrodes each placed on each surface of the element. The electrode placed on the piezoelectric element is preferably covered with electrically insulating material. The insulating material cover can electrically insulate the electrode from other elements in contact with the electrode such as the rigid plate. The ultrasonic oscillator 24 can be fixed on the surface of the rigid plate 23 by means of an epoxy resin adhesive.

A representative example of the material of the piezoelectric element is a piezoelectric ceramic material such as lead zirconate titanate compounds. The electrode can be made of metallic material such as silver or phosphor bronze. The piezoelectric element can be polarized in its thickness direction.

The ultrasonic oscillation is generated by applying electric energy (e.g., in the form of alternating current) to each ultrasonic oscillator 24 (to electrodes of the piezoelectric oscillator serving as the ultrasonic oscillator 24). The generated ultrasonic oscillation is then supplied to the cutting disk blade 22 reinforced by the rigid plates 23, and the cutting blade 22 shows ultrasonic vibration.

The rigid plates 23 attached to the cutting tool 20 serve to reinforce the cutting blade 22 if the cutting blade 22 is thin. This means that the cutting tool is given resistance to deflection in the thickness direction. Therefore, the cutting blade 22 reinforced by the rigid plates 23 hardly vibrates in the thickness direction even when the cutting blade 22 is thin. Therefore, the use of the cutting tool according to the invention enables to cut or groove an article with high accuracy even when the cutting blade is thin. For this reason, the cutting tool of the invention equipped with a thin cutting blade (1 mm thick or less, more particularly a thickness of 5 to 100 μm) can cut an article with high accuracy and high yield or groove an article with high accuracy and fine pitch.

A thin cutting blade is apt to deflect at its cutting edge when the edge is brought into contact with an article to be processed. If the cutting edge of the cutting blade is deflected by the contact with the article, the upper edge of the cut face or the upper edge of the grooved portion is sometimes broken (so-called “chipping”). The broken edges are naturally unsatisfactory. In contrast, since the cutting tool of the invention utilizes a cutting blade reinforced by the rigid plates, the cutting edge of the blade hardly deflects at the contact with the article. Accordingly, the cutting tool of the invention is advantageous in that the chipping is hardly observed in the case that the article is cut or grooved by a thin cutting blade.

The rigid plate 23 preferably has a thickness (thickness of the area to which the ultrasonic oscillator 24 is fixed) of 0.1 mm or more, more preferably 0.2 mm or more. Further, the rigid plate 23 has a thickness of 1 to 10% of its outer diameter. The rigid plate having this size preferentially vibrates in the radial direction rather than in the thickness direction when ultrasonic oscillation is applied. Accordingly, the cutting blade preferentially vibrates in the radial direction rather than in the thickness direction.

The rigid plate 23 preferably has an annular thicker portion 23a at its outer periphery which is in contact with the outer circumferential edge of the ultrasonic oscillator 24. The thicker portion 23a serves to assist to efficiently transmit to the cutting blade 22 a ultrasonic oscillation in the radial direction among the ultrasonic oscillation generated by the ultrasonic oscillator 24 via the rigid plate 23. Thus, the cutting blade 22 is more preferentially vibrates in the radial direction rather than in the thickness direction.

The cutting machine of the invention is described below.

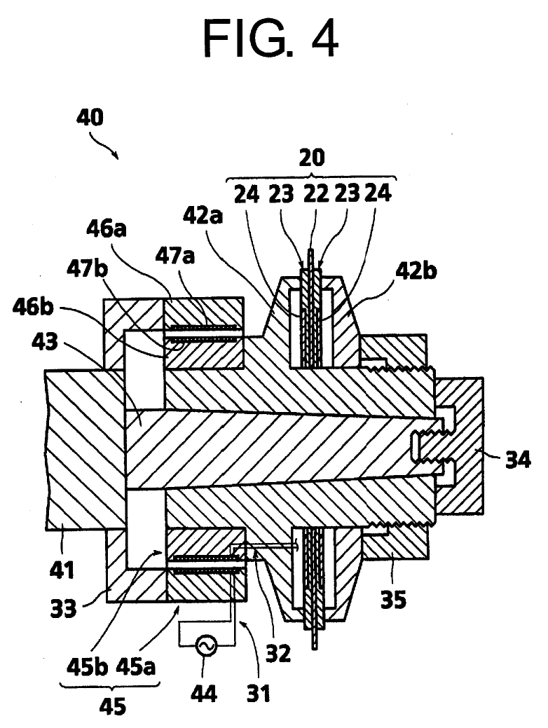

FIG. 4 is a side section of an embodiment of the cutting machine according to the invention.

The cutting machine 40 in FIG. 4 comprises a bearing 41; a rotating shaft 43 having a pair of flanges 42a, 42b extended radially which is rotatably supported by the bearing 41; a cutting tool 20 comprising a cutting disk blade 22 having a through-hole at a center thereof, an annular rigid plate 23 coaxially fixed to each face of the cutting blade 22, and an annular ultrasonic oscillator 24 having a smaller outer diameter than the rigid plate 22 which is coaxially fixed to an outer face of each rigid plate 22, the cutting tool 20 being fixed around the rotating shaft 43 and supported by the pair of flanges 42a, 42b on the rigid plate 23 in an area adjacent to its outer circumferential edge; and an electric power source 44 electrically connected to each ultrasonic oscillator 24.

The constitution of the cutting tool 20 of the cutting machine 40 in FIG. 4 is the same as that of the cutting tool 20 illustrated in FIGS. 2 and 3.

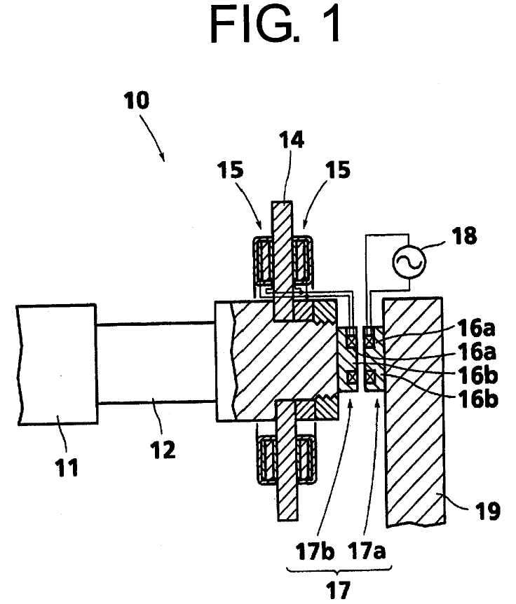

In FIG. 4, a part of the wiring 32 which electrically connect each ultrasonic oscillator 24 to an electric power-receiving unit 45b of the rotary transformer 45 is not shown in the vicinity of the ultrasonic oscillator 24. Each ultrasonic oscillator 24 can be electrically connected to the electric power-receiving unit 45b via electric wiring 32 in the same manner as in the cutting machine 10 of FIG. 1.

The cutting machine 40 in FIG. 4 can cut or groove an article by bring the cutting edge of the cutting blade 22 of the cutting tool 20 under rotation with application of ultrasonic oscillation generated by the ultrasonic oscillator 24 into contact with the article. Generally, a cutting liquid is supplied to the contact face between the cutting blade and the article under processing.

The cutting machine 40 can cut or groove the article with high accuracy regardless of the thickness of the cutting blade, because the cutting blade 22 vibrating under application of ultrasonic oscillation is reinforced by the rigid plates 23, 23. If the cutting machine 43 utilizes a cutting tool 20 equipped with a thin cutting blade, the article can be cut with high accuracy and high yield or grooved with high accuracy and fine pitch.

As is shown in FIG. 4, each rigid plate 23 of the cutting tool 20 is equipped with an annual ultrasonic oscillator 24 having an outer diameter smaller than the diameter of the rigid plate 23. The cutting tool 20 is supported by a pair of flanges 42a, 42b fixed around the rotating shaft 43 via the rigid plates 23 in the outer periphery area. If the piezoelectric element serving as the ultrasonic oscillator 24 is directly supported by the flanges 42a, 42b, the piezoelectric ceramic material of the piezoelectric element may be broken.

As is shown in FIG. 4, the cutting machine 40 comprises a rotary transformer 45 which is composed of an electric power supply unit 45a fixed to the bearing 41 and an electric-receiving unit 45b fixed to the rotating shaft 43. Thus, it is preferred that the electric power source 44 is electrically connected to each ultrasonic oscillator 24 via the rotary transformer 45.

The rotary transformer 45 is placed for transmitting electric energy to each ultrasonic oscillator 24 (which rotates with the cutting blade 22) from the power source 44 in the procedure for cutting or grooving the article.

The rotary transformer 45 comprises an electric power supply unit 45a and an electric power-receiving unit 45b which are arranged adjacently with a small space. Each of the power supply unit 45a and power-receiving unit 45b is in an annual form.

The electric power supply unit 45a comprises an annual stator core 46a and a stator coil 47a, and the electric power-receiving unit 45b comprises an annual rotor core 46b and a rotor coil 47b. Each of the stator core 46a and rotor core 46b is made of magnetic material such as ferrite and has an annual groove formed along the periphery. Each of the stator coil 47a and rotor coil 47b has an coiled wiring annually arranged along the groove formed in the stator core 46a and rotor core 46b.

To the stator coil 47a of the power supply unit 45a is electrically connected a power source 44 via an electric wiring 31, while to the rotor coil 47b of the power-receiving unit 35b is electrically connected each ultrasonic oscillator 24 of the cutting tool 20 via an electric wiring 32. Thus, the power source 44 is electrically connected to each ultrasonic oscillator 24 via the rotary transformer 45.

In the rotary transformer, the stator coil 47a and rotor coil 47b are arranged adjacently to each other. Therefore, when the electric energy generated by the power source 44 is applied to the stator coil 47a, both coils are coupled together. The electric energy applied to the stator coil 47a is then transmitted to the rotor coil 47b even though the rotor coil 47b (or power-receiving unit 45b) rotates around its axis. Thus, the electric energy generated by the power source 44 is transmitted to each ultrasonic oscillator 24 which rotates with the cutting blade 22, when the procedure for cutting or grooving is performed.

In the cutting machine 40, the power supply unit 45a of the rotary transformer 45 is fixed to the bearing 41 via the supporting means 33, while the power-receiving unit 45b is fixed to the rotating shaft 43 via the flange 42a. Thus, the rotary transformer 45 is arranged on the side of the bearing 41 of the cutting tool 20, and hence the cutting tool 20 (or cutting blade 22) can be easily dismounted from the front end of the rotating shaft 43. Therefore, it is easy to replace a used and worn cutting blade 22 with a new cutting blade.

Further, since the rotary transformer 45 is arranged on the side of the bearing 41 of the cutting tool 20 in the cutting machine 40, the position of the power-receiving unit 45b is hardly shifted (as compared with the configuration of the cutting machine shown in FIG. 1 in which the power-receiving unit is fixed to the front end of the rotating shaft) when the rotating shaft 43 is slightly deflected by accidental contact between the cutting blade 22 and the article under processing. Thus, since the relative arrangement between the power supply unit 45a and power-receiving unit 45b of the rotary transformer 45 hardly varies, the electric energy generated by the power source 44 can be stably transmitted to each ultrasonic oscillator 24 of the cutting tool 20, and then the ultrasonic oscillation is stably applied to the cutting blade 22.

Furthermore, in the case that the processing is performed in the cutting machine 40 by moving the cutting blade 22 up and down and right and left relative to the position of the article under processing, the electric energy generated by the power source 44 can be stably transmitted to each ultrasonic oscillator 24 of the cutting tool 20, because the rotary transformer 45 is moved with the cutting blade 22, that is, because the relative arrangement between the power supply unit 45a and power-receiving unit 45b of the rotary transformer 45 does not vary. Thus, the ultrasonic oscillation is stably applied to the cutting blade 22.

In the cutting machine of the invention, the power supply unit of the rotary transformer can be directly or indirectly fixed to the bearing. For the indirect fixation, for instance, if the bearing is placed within a rotation-driving device for rotating the rotating shaft, the power supply unit can be directly or indirectly (via supporting means) fixed to the rotation-driving device or its coverage. In FIG. 4, the power supply unit 45a is indirectly fixed to the bearing 41 via supporting means 33.

Similarly, in the cutting machine of the invention, the power-receiving unit of the rotary transformer can be directly or indirectly fixed to the rotating shaft. In the cutting machine 40 shown in FIG. 4, the power-receiving unit 45b is indirectly fixed to the rotating shaft 43 via the flange 42a.

Otherwise, the electric energy can be supplied from a power source to each ultrasonic oscillator of the cutting machine according to the invention by, for instance, a slip ring. However, since the power supply unit and power-receiving unit of the rotary transformer are arranged under non-contact conditions, the use of a rotary transformer is advantageous in that the electric energy can be transmitted still stably to each ultrasonic oscillator even when the cutting blade is caused to rotate at a high rotation rate (e.g., 10,000 rotation/min. or more).

The cutting machine 40 of FIG. 4 can be assembled, for instance, by the following procedures. First, the power supply unit 45a of the rotary transformer 45 is fixed to the bearing 41 supporting the rotating shaft 43 via the supporting means 33, and then the power source 44 is electrically connected to the stator coil 47a via the wiring 31. Subsequently, the power-receiving unit 45b of the rotary transformer 45 is fixed to the flange 42a, and then the fixed structure is temporarily arranged around the rotating shaft 43 by means of a bolt 34. Subsequently, the rigid plate 23 and ultrasonic oscillator 24 are both fixed to each of the cutting disk blade 22 by an adhesive such as an epoxy resin adhesive. Thus manufactured cutting tool is then mounted around the rotating shaft 43. Thereafter, the rotor coil 47b of the power-receiving unit 45b is electrically connected to each ultrasonic oscillator 24 via the wiring 32. Finally, the flange 42b is mounted and temporarily fixed with a nut 35 to the rotating shaft 43. Thus, the cutting machine 40 is assembled.

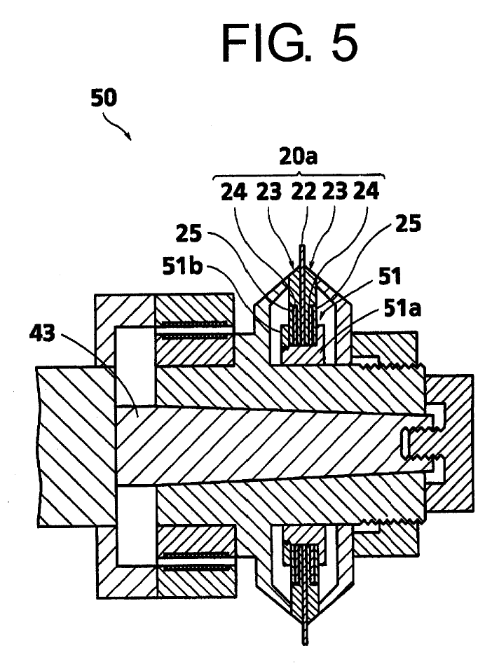

FIG. 5 is a side section of another embodiment of the cutting machine according to the invention. In FIG. 5, the constitution of the cutting machine 50 is the same as the constitution of the cutting machine 40 shown in FIG. 4, except that the cutting disc blade 22 of the cutting tool 20a is bound to both rigid plates 23 and both ultrasonic oscillators 24 by means of a binding means 51 provided to a circumferential edge of the through-hole of the cutting blade 22. The binding means 51 in FIG. 5 comprises a bolt 51a having a through-hole at its center and a nut 51b.

The binding means 51 assists to arrange the cutting tool 20a around the rotating shaft 43 in the perpendicular direction to the shaft 43 stably and with high precision. Further, the oscillation-applying means composed of a pair of annular rigid plates 23 and an annular ultrasonic oscillator 24 having a smaller outer diameter than the rigid plate 23 which is coaxially fixed to an outer face of each rigid plate 23 can be easily dismounted from the cutting blade 22. Therefore, it is easy to remove a used and worn cutting blade 22 from the oscillation-applying means and mount a new cutting blade. This means that an expensive ultrasonic oscillator can be reused.

On each of surfaces of the cutting blade 22 is arranged the rigid plate 23 preferably via contact material such as grease. Then, the cutting blade 22 and rigid plates 23 are preferably combined (or combined temporarily) with the ultrasonic oscillators 24 by the binding means 51. The contact material assists to efficiently transmit the ultrasonic oscillation generated by the ultrasonic oscillator 24 to the cutting blade 22 because the contact material reduces reflection of the ultrasonic oscillation on the interface between the rigid plate 23 and the cutting blade 22.

In addition, each ultrasonic oscillator 24 is preferably covered with an insulating material layer 25 on the outer surface in contact with the binding means 51. The insulating material layer 25 serves to keep the ultrasonic oscillator 24 on the surface of the cutting blade 22 from contact with the binding means 51 and then from production of short current with the binding means (in the case that the binding means 51 is made of electroconductive material). The insulating material layer 25 is preferably made of resinous material so that the piezoelectric element constituting the ultrasonic oscillator 24 does not suffer from production of cracks which is possibly observed when the cutting tool 20a is bound by the bolt 51a and nut 51b of the binding means 51.

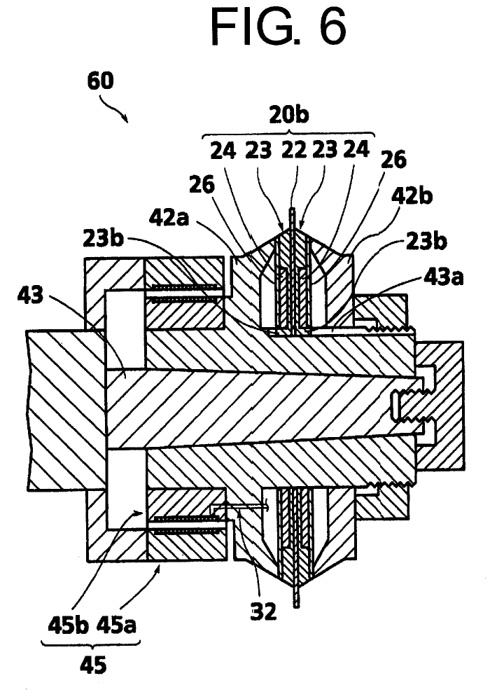

FIG. 6 is a side section of a further embodiment of the cutting machine according to the invention. The cutting machine 60 in FIG. 6 is the same as the cutting machine 40 in FIG. 4 except that the rigid plate 23 of the cutting tool 20b is coated with a resinous material layer 26 in the area outer than the ultrasonic oscillator 24.

As is shown in FIG. 6, the pair of flanges 42a, 42b support the cutting tool 20b preferably via the resinous material layer 26. In the cutting machine 60 of FIG. 6, the resinous material layer 26 is placed on the outer face of the rigid plate 23. Generally, the pair of flanges 42a, 42b are made of metallic material such as aluminum, iron or stainless steel. If the rigid plate 23 is coated with the resinous material layer 26, the ultrasonic oscillation generated by each ultrasonic oscillator 24 is hardly transmitted to the flanges 42a, 42b because the acoustic impedance of the resinous material layer 26 greatly differs from that of the flanges 42a, 42b. Accordingly, the ultrasonic oscillation generated by each ultrasonic oscillator 24 is efficiently transmitted to the cutting edge of the cutting blade 22. The resinous material layer can be placed on the front end of each flange.

The resinous material layer 26 can be made of polyethylene or polypropylene. The resinous material layer can be formed by coating a resinous material or laminating a resinous film. The resinous film can be a fiber-reinforced resinous film.

There is a case that the wiring 32 electrically connecting the power-receiving unit 45b to each ultrasonic oscillator 24 is broken, if a great load is applied to the rotating blade 22 for cutting or grooving and the cutting tool 20b stops as whole (meaning that the blade 22 shows slippage on the flanges 42a, 42b) resulting in continuous rotation of the power-receiving unit of the rotary transformer 45. If the rigid plate 23 of the cutting tool 20b has a protrusion 23b it its inner circumferential edge area and the protrusion 23b is engaged with the groove 43a formed in the rotating shaft 43 of the cutting machine 60 in the length direction as is shown in FIG. 6, the cutting blade 22 of the cutting tool 20b only can stop (shows slippage on each rigid plate 23) when a great load is applied to the rotating blade 22. In this case, the oscillation-applying means (a pair of the rigid plates 23 to which a ultrasonic oscillator 24 is fixed) keeps its rotation with the rotating shaft 43. Therefore, the wiring 32 is hardly broken.

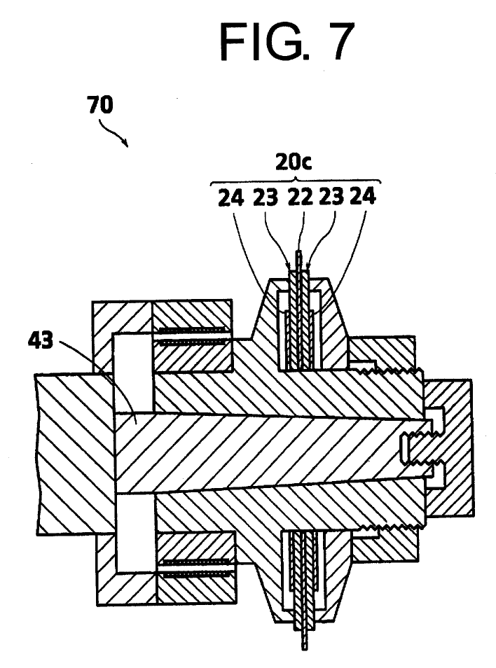

FIG. 7 is a side section of a still further embodiment of the cutting machine according to the invention. The cutting machine 70 has the same constitution as the cutting machine 40 in FIG. 4, except that the rigid plate 23 of the cutting tool 20c has a uniform thickness (having no thicker portion). The cutting tool 20c equipped with such rigid plate 23 is advantageous in that its production is easy.

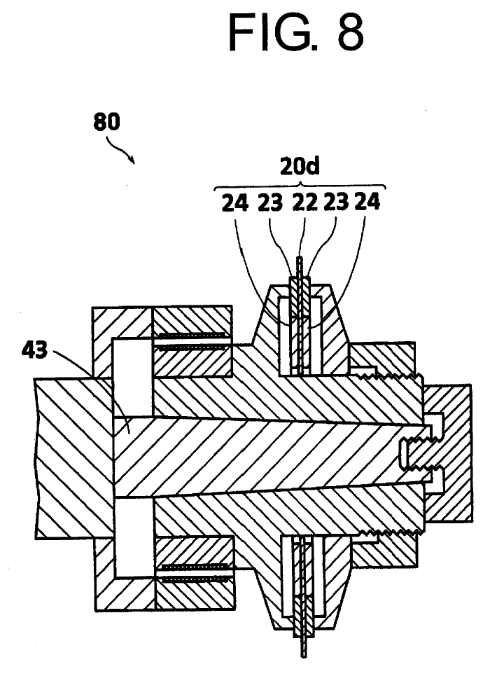

FIG. 8 is a side section of a still further embodiment of the cutting machine according to the invention. In FIG. 8 the cutting machine 80 has the same constitution as the cutting machine 40 in FIG. 4, except that the annular ultrasonic oscillator 24 having a smaller outer diameter than the rigid plate 23 which is coaxially fixed to the cutting blade in contact with an inner circumferential edge of each rigid plate 23 of the cutting tool 20d.

As is shown in FIG. 8, the inner circumferential edge of the rigid plate 23 of the cutting tool 20d is kept in contact with the outer circumferential edge of the ultrasonic oscillator 24. Hence, among the ultrasonic oscillation, the ultrasonic oscillation vibrating along the radial direction of the oscillator 24 is efficiently transmitted to the cutting blade 22 via the rigid plate 23. Therefore, the cutting blade 22 can vibrate preferentially in the radial direction rather than the thickness direction.

In addition, if the ultrasonic oscillator 24 is arranged apart from the rotating shaft 43, the ultrasonic oscillation does not escape to the rotating shaft 43, and the ultrasonic oscillation generated by the ultrasonic oscillator 24 is efficiently transmitted to the cutting blade 22.

What is claimed is:

1. A cutting tool comprising a cutting disk blade having a through-hole at a center thereof, an annular rigid plate coaxially fixed to each face of the cutting blade, and an annular ultrasonic oscillator having a smaller outer diameter than the rigid plate which is coaxially fixed to an outer face of each rigid plate or to the cutting blade in contact with an inner circumferential edge of each rigid plate.

2. The cutting tool of claim 1, in which the cutting disk blade has a thickness of 1 mm or less.

3. The cutting tool of claim 1, in which each rigid plate has a thickness of 10% of an outer diameter thereof.

4. The cutting tool of claim 1, in which each rigid plate is covered with resinous material on an area which is outer than the ultrasonic oscillator.

5. The cutting tool of claim 1, in which each rigid plate has an annular thicker area on a periphery thereof which is in contact with an outer circumferential edge of the ultrasonic oscillator.

6. The cutting tool of claim 1, in which the cutting disc blade is bound to both rigid plates and both ultrasonic oscillators by means of a binding means provided to a circumferential edge of the through-hole of the cutting disk blade.

7. A cutting machine comprising a bearing; a rotating shaft having a pair of flanges extended radially which is rotatably supported by the bearing; a cutting tool comprising a cutting disk blade having a through-hole at a center thereof, an annular rigid plate coaxially fixed to each face of the cutting blade, and an annular ultrasonic oscillator having a smaller outer diameter than the rigid plate which is coaxially fixed to an outer face of each rigid plate or to the cutting blade in contact with an inner circumferential edge of each rigid plate, the cutting tool being fixed around the rotating shaft and supported by the pair of flanges on the rigid plate in an area adjacent to an outer circumferential edge thereof; and an electric power source electrically connected to each ultrasonic oscillator.

8. The cutting machine of claim 7, in which the cutting diskblade has a thickness of 1 mm or less.

9. The cutting machine of claim 7, in which each rigid plate has a thickness of 10% of an outer diameter thereof.

10. The cutting machine of claim 7, in which each rigid plate is covered with resinous material on an area which is outer than the ultrasonic oscillator.

11. The cutting machine of claim 7, in which each rigid plate has an annular thicker area on a periphery thereof which is in contact with an outer circumferential edge of the ultrasonic oscillator.

12. The cutting machine of claim 7, which further comprises a rotary transformer composed of an electric power supply unit fixed to the bearing and an electric receiving unit fixed to the rotating shaft, the electric power source being connected to each ultrasonic oscillator via the rotary transformer.

13. The cutting machine of claim 7, in which the pair of flanges support the cutting tool via resinous material.

14. Oscillation-applying means comprising a pair of annular rigid plates each having a through-hole at a center thereof and an annular ultrasonic oscillator having a smaller outer diameter than the rigid plate which is coaxially fixed to an outer face of each rigid plate or arranged in contact with an inner circumferential edge of each rigid plate.

15. The oscillation-applying means of claim 14, in which each rigid plate has a thickness of 10% of an outer diameter thereof.

16. The oscillation-applying means of claim 14, in which each rigid plate is covered with resinous material on an area which is outer than the ultrasonic oscillator.

17. The oscillation-applying means of claim 14, in which each rigid plate has an annular thicker area on a periphery thereof which is in contact with an outer circumferential edge of the ultrasonic oscillator.
